(19) United States
(12) Patent Application Publication
(10) Pub. No.: US 2013/0054686 A1
(43) Pub. Date: Feb. 28, 2013

(54) Content enhancement utility

(71) Applicants: Mark Hassman, Oak Hill, VA (US); Derek Raymond Garnier, Oakland, CA (US); Michael Paul Cancilla, Alamada, CA (US)

(72) Inventors: Mark Hassman, Oak Hill, VA (US); Derek Raymond Garnier, Oakland, CA (US); Michael Paul Cancilla, Alamada, CA (US)

(21) Appl. No.: 13/199,395

(22) Filed: Aug. 29, 2011

(51) Int. Cl. G06F 15/16

(52) U.S. Cl. 709/204

(57) ABSTRACT

The invention relates to a new methodology for modifying the appearance of an existing work without modifying the source code of the existing work even by a viewer or listener who did not create the existing work. This capability enables viewers to annotate or communicate information about existing works in ways that were not possible before. For example a webpage from a restaurant (an existing work) could be annotated with notes describing which entre was my favorite and then this new view of the restaurant's webpage could be shared with a friend; my friend would then see the webpage including notes identifying my favorite entre on their client device. This capability provides an entirely new dimension to collaboration and training across computer networks and across the internet.

### BACKGROUND OF THE INVENTION

Intranets and the Internet are commonly used today to access works that reside on remote sources of computing information or data; such sources include yet are not limited to an individual computer or server on a computer network. Webpages, text, images, audio, video and other media viewed or listened to that is accessed from a local or remote source are examples of “existing works” that may be downloaded or partially downloaded and then viewed on a personal computing device or “client device”.

A viewer of “existing works” typically has no ability or facility to modify an “existing work” that he views. Modifying an “existing work” typically is only performed by a creator of the work or by someone with the access to edit or modify the original operating software of an “existing work”. Such original operating software is commonly referred to as source code. For example modifying the appearance of a webpage to show different content conventionally requires the work itself to be modified at its lowest level, at the source code; there is no facility to add content to the work without modifying the source of the work.

For the remainder of this document the terms existing work or existing works (without quotes) will refer to a creation intended to be viewed or listened to by a viewer or listener without modification; and where the only facility to modify the creation is to modify its source, at a very basic level by a creator or an editor. Existing works include yet are not limited to a webpage, text document, XML documents, HTML documents, photos, images, audio, video and other media that may be viewed or listened to on an electronic device that is accessed from a local or remote source.

A “client device” includes yet is not limited to a personal computer, a mobile personal computing device, a cell phone, smart phone, tablet computer, personal data assistant, or other electronic device capable of displaying an existing work. For the remainder of this document the term client device (without quotes) is a device where content, including existing works may be viewed or listened to by a viewer or listener.

The invention described in this document relates to a new methodology for modifying the appearance of an existing work without modifying the source code of the existing work by a viewer or listener who did not create the existing work. This capability enables viewers to annotate or communicate information about existing works in ways that were not possible before. For example a webpage from a restaurant (an existing work) could be annotated with notes describing which entre was my favorite and then this new view of the restaurant's webpage could be shared with a friend; my friend would then see the webpage including notes identifying my favorite entre on their client device. This capability provides an entirely new dimension to collaboration and training across computer networks and across the internet.

### BRIEF SUMMARY OF THE INVENTION

Typically a viewer of “existing works” typically has no ability or facility to modify an “existing work” that he views. Modifying an “existing work” typically is only performed by a creator of the work or by someone with the access to edit or modify the original operating software of an “existing work”. Such original operating software is commonly referred to as source code. For example modifying the appearance of a webpage to show different content conventionally requires the work itself to be modified at its lowest level, at the source code; there is no facility to add content to the work without modifying the source of the work.

The invention described herein relates to a new methodology for modifying the appearance of an existing work without modifying the source code of the existing work by a viewer or listener who did not create the existing work. This capability enables viewers to annotate or communicate information about existing works in ways that were not possible before. For example a webpage from a restaurant (an existing work) could be annotated with notes describing which entre was my favorite and then this new view of the restaurant's webpage could be shared with a friend; my friend would then see the webpage including notes identifying my favorite entre on their client device. This capability provides an entirely new dimension to collaboration and training across computer networks and across the internet.

The invention may be implemented by various means yet each implementation performs the function of adding content to an existing work without changing the source code of the existing work. The invention may include separate modules that communicate with each other and with an application displaying an existing work. One embodiment has three modules, a smudge lab controller, a smudge lab rendering engine, and a data repository.

This methodology for adding content to an existing work without changing the source code of the existing work may be implemented in software, firmware, in hardware, or combination thereof. The invention operates at a level above the existing work in the system architecture and displays modifications to the appearance of an existing work without modifying the source code of the existing work. Such modifications will be referred to as smudges, enhancements, or smudge lab objects in this disclosure. Smudges, enhancements, or smudge lab objects are superimposed content over an existing work. Inserted content includes yet is not limited to contain visual and/or audio smudge lab objects. These smudges, enhancements, or smudge lab objects may also be shared with other computers or client devices.

Any feature or combination of features described or referenced herein are included within the scope of the present invention provided that the features included in any such combination are not mutually inconsistent as will be apparent from the context, this specification, and the knowledge of one skilled in the art. In addition, any feature or combination of features described or referenced may be specifically included, replicated and/or excluded, in any combination, in/from any embodiment of the present invention. For purposes of summarizing the present invention, certain aspects, advantages and novel features of the present invention are described or referenced. Of course, it is to be understood that not necessarily all such aspects, advantages or features will be embodied in any particular implementation of the present invention. Additional advantages and aspects of the present invention are apparent in the following detailed description and claims that follow.

### DETAILED DESCRIPTION OF THE INVENTION

Typically a viewer of “existing works” typically has no ability or facility to modify an “existing work” that he views. Modifying an “existing work” typically is only performed by a creator of the work or by someone with the access to edit or modify the original operating software of an “existing work”. Such original operating software is commonly referred to as source code. For example modifying the appearance of a webpage to show different content conventionally requires the work itself to be modified at its lowest level, at the source code; there is no facility to add content to the work without modifying the source of the work.

The invention described herein is a methodology for adding content to an existing work without modifying the source code of the existing work. This method may be implemented in software, firmware, in hardware, or combination thereof. The invention operates at a level above the existing work in the system architecture and displays modifications to the appearance of an existing work without modifying the source code of the existing work. Such modifications will be referred to as smudges, enhancements, or smudge lab objects in this disclosure. Smudges, enhancements, or smudge lab objects are superimposed content over an existing work. Content superimposed over an existing work as used herein shall include yet is not limited to images, text, video, visual and/or audio objects. Such inserted content referred herein as smudges, enhancements, or smudge lab objects may also be shared with other computers or client devices.

Typically, yet not necessarily there are three pieces used to implement the invention, these are: a smudge lab controller, a smudge lab rendering engine, and a smudge lab data repository.

In some embodiments functionality contained within these pieces may be combined, for example the smudge lab controller and the smudge lab rendering engine may be combined in a single complied piece of software where the smudge lab data repository may be implemented in a second piece of software. Whether implemented in one or more pieces of software, firmware, hardware, or combination thereof the invention relates to a methodology and product of one or more state machines that enables the appearance of an existing work to be changed without modifying the source code of the existing work.

A state machine is a mathematical relationship flow used to design digital logic or computer programs implemented in software, firmware, hardware, or combination thereof, a behavior model composed of a number of states, transitions between those states, and actions, similar to a flow graph in which one can inspect the way logic runs. When certain conditions are met software, firmware, or combination thereof will transition from one state to another. Furthermore one state machine may operate and communicate with one or more other state machines when managing a series of events and or states consistent with the invention.

Software architectures commonly contain a hierarchy of rings or protection domains that provide different levels of access to resources. The most trusted domain is typically referred to as Ring 0. Software operating on Ring 0, or operating with Ring 0 access privileges frequently interacts directly with hardware in the device and has the highest level of privileges of any software run in the computer system.

Software operating with Ring 0 access privileges may be implemented within the computer operating system software architecture at a core level commonly referred to as Kernel Mode, or at a user level commonly referred to as User Mode. Software implemented within Kernel Mode is referred to in this disclosure as software operating on Ring 0. Software operating with Ring 0 access privileges is referred to in this disclosure as software implemented in User Mode that passes commands or instructions to Kernel Mode with Ring 0 access and security privileges.

One embodiment of the invention is implemented in software operating with Ring 0 access privileges within a web browser. One example is where a web browser pug-in communicates using the Netscape Plugin Application Interface (NPAPI) compatible Application Program Interfaces (APIs). NPAPI is a communication architecture that is supported by various web browsers. Plug-ins are additional software elements that provide extended capabilities to the web browser, once initiated they may play an audio file, play a video, or send other data types to the browser without the need for running an application external to the web browser. Plug-ins thus enables a browser to play or render content of data types not supported by the browser itself. In some embodiments of the invention a plug-in uses NPAPI compatible APIs to render data on top of an existing work. NPAPI allows 3rd parties to write extensions to browser functionality, and Smudge Lab exploits this by extending the functionality of browsers like Firefox by providing NPAPI compatible extensions.

An example of a three piece software implementation is where the smudge lab controller is implemented in JavaScript, the smudge lab rendering engine is implemented in C++, and the smudge lab data repository is a web application implemented in Microsoft IIS and SQL. Communication occurs between the smudge lab data repository and the smudge lab controller using WebServices/SOAP over HTTP, and between the smudge lab controller and the smudge lab data repository using NPAPI.

Similar software implementations may be implemented using other programming languages or utilities than those described above. They may be compatible with non-NPAPI browser communication architectures compatible with Internet Explorer or other browsers. They may be compatible with other computer operating system software architectures.

Regardless of the specific implementation there are several Smudge Lab processes that are implemented by the invention interacting with an application include yet are not limited to:
a. Uniquely identifying particular existing works, typically a Smudge Lab controller process.
b. Uniquely identifying and documenting objects or items within existing works, typically a Smudge Lab controller process.
c. Inserting and documenting smudges over each unique existing work without modifying the existing work, typically a Smudge Lab rendering engine process
d. Storing and/or retrieving smudges or Smudge Lab overlays that are mapped to unique objects or items in an existing work, typically a Smudge Lab data repository process.

Web pages may be uniquely identified by their URL or other unique identifying attribute. Existing works not sourced online may be identified using a computed hash of the work or other unique identifying attributes including yet not limited to a file name.

When opening and displaying an existing work that may have existing Smudge Lab enhancements, a series of process steps are invoked. One embodiment of opening and displaying an existing work is shown in FIG. 1 and is described below.
a. “Open an existing work” 1. Initiation of an existing work including yet not limited to a webpage, text document, XML, HTML or other. Frequently yet not necessarily an existing work is initiated by a user opening an application to view an existing work.
b. Application displays the native existing work and the Smudge lab Controller converts the Existing Work (EW) to a Unique Identifier (UID): “Application Displays Native EW; Smudge Lab Controller converts EW to UID” 2.
The contents of the existing work may be displayed before querying for the existence of smudge lab overlay data relating to the specific existing work.
When an existing work is loaded and smudge-lab functionality is enabled smudge lab will analyze the contents of the existing work and generate data wherein the location of significant objects in the existing work are described as uniquely reference-able elements or objects.
c. “Smudge lab controller Queries the Smudge Lab Data Repository for Overlay Data” 3. Here the smudge lab controller checks with the smudge lab data repository checking for the existence of enhancements relating to a UID.
d. For a given existing work if the data repository has record of existing smudge lab enhancements relating to a specific UID, the smudge lab data repository will prepare to send overlay data relating to the UID back to the smudge lab controller. Overlay data may include some or all of the following, yet are not limited to them: type of smudge, name of the smudge, values associated with the smudge, reference coordinates of the smudge regarding its location of appearance over the existing work, and URL designation. Values associated with the smudge may include some or more of the following, yet are not limited to them: location, size, skew, color, opacity, volume, playback speed, font, and text. “Smudge Lab Data Repository Returns Overlay Data” 4. Here overlay data that relates to the UID is returned to the controller from the data repository.
e. “Are there Smudges to Display?” 5.
When there are smudges to display on the existing work, the controller will prepare to retrieve them from local storage, from a centralized data store, or from both local and centralized storage.
f. “Rendering Engine Determines Placement of Smudges” 6.
At this point information and overlay data regarding each smudge is reviewed. The information reviewed include may include some or more of the following, yet are not limited them: to type of smudge, name of the smudge, values associated with the smudge, reference coordinates of the smudge regarding its location of appearance on the existing work, and URL designation.
g. “Rendering Engine Displays Smudge lab Smudges” 7.
The smudge lab rending engine generates and displays the smudges on the existing work. Attributes or values associated to each smudge include may include one or more of the following, yet are not limited to them: location, size, skew, color, opacity, volume, orientation, playback speed, font, and text.

Inserting smudges is another process critical to smudge lab. A fundamental way to insert an enhancement is to drag an object from a sidebar and drop it onto an existing work.

An example of the Drag/Drop Process is shown in FIG. 2:
a. Smudge lab sidebar opened by a user: “User Opens SL Sidebar SL Event Listener Initiated” 8.
In one embodiment the smudge lab event listener is referred to as a “drag/drop event listener function”. Typically when the application displaying an existing work is a WEB browser the drag/drop event listener is added to the browser window.
b. Drag enhancement from the sidebar to the browser window.
A user selects a smudge lab object and drags it over the existing work (EW); in FIG. 2 “User Selects & Drags an SL Object over an EW” 9. This process may be initiated by clicking on a smudge lab object (smudge) in the sidebar and holding a mouse button down over the smudge lab object while it is moved. This process is similar to the actions of selecting and dragging basic drawing elements or files from one place to another in popular drawing or operating systems software. This drag function may be implemented in various ways standard in the art; here however this action is facilitated by a new architecture.
c. Drop enhancement onto the Existing Work window.
A user will then drop the smudge lab object (smudge) over the existing work; in FIG. 2 “User releases SL Object” 10. In one embodiment a user simply drops a smudge lab object by simply by releasing a depressed mouse button at a desired location over the existing work.
When an image is dropped, the smudge lab controller calls a DROP event function; in FIG. 2 “SLC Drop called” 11. The DROP event function first analyzes and validates the integrity of the smudge that is dropped over an existing work; in FIG. 2 “SL DROP Analyzes & Validates SL Object Integrity 12. The smudge lab DROP event function then calls the smudge lab controller ADD OBJECT function; “Drop calls SLC Add Object” 13.

The smudge lab controller ADD OBJECT function initiates the smudge lab rendering engine; in FIG. 2 “SLC ADD OBJECT initiates SLRE” 14.
In one embodiment ADD OBJECT elements are inserted into a data structure referred to as a WEB page's Document Object Model (DOM). The DOM is a cross-platform language-independent convention for representing and interacting with objects in HTML, XHTML, and XML documents.
ADD OBJECT also adds attributes from dropped smudges to an in-memory cache. Dropped smudge attributes include yet are not limited to: an object identifier (object_id), a source universal record locator (source_url), an object type (object_type), or object size (object_size).
At this point in time the smudge lab controller ADD OBJECT function calls another smudge lab controller function, ASSOCIATE REFERENCE OBJECT; in FIG. 2 “SLC Add Object calls SLC ASSOCIATE REF. OBJECT” 15. The ASSOCIATE REFERENCE OBJECT function locates and associates the closest in-page unique reference object and creates the necessary linking between the newly dropped smudge object and the in-page object. An in page reference object is an object contained in the original existing work and is not itself a smudge lab object (smudge) overlaid over the existing work. This function also commits new data to in-memory cache. By locating, associating, and storing this reference information relative to an in-page object. Smudges and their locations are typically retained and recorded in a memory cache so they can be drawn over the existing work. Smudges and their related attribute data may be saved in the data repository when a user wishes.

At this point in time function ADD OBJECT calls the smudge lab rendering engine function CREATE (in some embodiments create( )); in FIG. 2 “SLC Add Object calls SLRE CREATE” 16. The smudge lab CREATE function then validates the smudge object's attributes; in FIG. 2 “SLRE CREATE validates SL Object Attributes” 17. Attributes of a smudge include yet are not limited to: the x/y coordinates where the smudge lab object is located, the size of the object, or a source_url.
Then the smudge lab rendering engine retrieves the smudge lab object's binary data; in FIG. 2 “SLRE CREATE retrieves SL Object's binary data” 18.
The final step in this embodiment of the invention is where CREATE draws the new object above the existing work window in the desired location; in FIG. 2 “CREATE draws new Object above EW Window” 19.
In one embodiment function Add OBJECT in the smudge lab controller calls function CREATE within the smudge lab rendering engine and does so by calling a NPAPI-based function.
Functions described above and shown in FIG. 2 may be implemented with different function names yet provide equivalent functionality; for example: DROP may be implemented as dropListener( ), ADD OBJECT may be implemented as addDPobject( ), ASSOCIATE REFERENCE OBJECT may be referred to as associate_reference_object( ), CREATE may be implemented as create ( ), SAVE may be implemented as save( ), ADD REPLACEMENT OBJECT may be implemented as AddReplacementObject( ), and UPDATE REPLACEMENT OBJECT may be implemented as UpdateReplacementObject( ).
NOTE: The functions discussed above and in FIG. 2 are for illustrative purposes and describe certain embodiments of the invention's drag and drop process. The invention is not limited to these embodiments. Variations of function structure, operation, and naming convention may be modified in ways obvious to one of average skill in the art to achieve similar results are considered alternate embodiments of the invention.

| Figure 2 Function: | Brief Description |
|---|---|
| DROP | Smudge Lab Drop Controller Function that analyzes & |
| | validates the integrity of a new or modified |
| | smudge, then places the smudge over an existing |
| | work. |
| ADD OBJECT | Smudge Lab Controller Function that communicates |
| | with the Smudge Lab Rendering Engine to embed a |
| | smudge into existing work's data structure. |
| Document Object Model (DOM) | The DOM is a cross-platform language-independent |
| | convention for representing and interacting with objects |
| | in HTML, XHTML, and XML documents. |
| ASSOCIATE REFERENCE OBJECT | Smudge Lab Controller Function that locates and |
| | associates the location of a new or modified smudge |
| | relative to the location of an in page reference object in |
| | an existing work. |
| CREATE | Smudge Lab Rendering Engine Function called by ADD |
| | OBJECT that validates a smudge's attributes. |
| SAVE | Smudge Lab Controller Function that saves new or |
| | updated smudge attributes. |
| INFO | Smudge Lab Rendering Engine Function called by SAVE |
| | that returns smudge attributes to the Smudge Lab |
| | Controller |
| ADD REPLACEMENT OBJECT | Data Repository Function used with SAVE and INFO |
| | functions when saving new smudges |
| UPDATE REPLACEMENT OBJECT | A Data Repository Function used with SAVE and INFO |
| | functions when saving updated smudges |

Saving smudge lab enhancements is another process used in the invention. One embodiment of saving enhancements to an existing work is reviewed below and in FIG. 3.
In one embodiment a user clicks the save button in the smudge lab sidebar; in FIG. 3 “User Clicks Save” 20. Function SAVE is a smudge lab controller function that first determines a unique page ID; in FIG. 3 “SAVE determines UID” 21.
The smudge lab controller identifies object that have changed since the last save operation; in FIG. 3 “SLC identified SL Objects recently updated” 22. Function SAVE also typically will retrieve access permissions from the smudge lab sidebar where user, group, anonymous, or other permissions are evaluated. Access permissions will be utilized for regulating who can access or modify smudges saved in a data repository.
For each new or modified smudge, the smudge lab controller then calls the smudge lab rendering engine INFO function; in FIG. 3 “SLC calls SLRE INFO” 23. In response the smudge lab rendering engine returns object attributes to the smudge lab controller; in FIG. 3 “SLC INFO returns SL Object Attributes to SLC” 24. Attributes of the new object include yet not limited to object ID (object_id), screen coordinates, transparency, rotation, & colorization. In some embodiments function INFO is implemented using a NPAPI based call.

The smudge lab controller then verifies that the new object's matching criteria are consistent with the object's related attributes that include yet are not limited to pixel offset, and an in page reference object unique id; in FIG. 3 “SLC determines SLObject matching criteria & Attributes” 25. Matching criteria matches native elements or objects contained within an existing work to the location where a smudge is located over the existing work.
When preparing to save new objects the smudge lab controller calls one of two functions in the smudge lab data repository ADD REPLACEMENT OBJECT or UPDATE REPLACEMENT OBJECT; in FIG. 3 “SLC call SLDR AddRepOBJECT or UpRepOBJECT” 26. Finally the smudge lab data repository ADD REPLACEMENT OBJECT or UPDATE REPLACEMENT OBJECT function validates and then stores the data relating to the objects to the data repository; in FIG. 3 “SLDR AddRepOBJECT or UpRepOBJECT Validates & Stores Data” 27.

The classical “Microsoft Windows Architecture with Smudge Lab Functionality” is shown in FIG. 4.
Kernel Mode 30 contains the following elements Executive Services 31, I/O Manager 32, File Systems 33, Security Reference Monitor 34, Virtual Memory Manager 35, Process Manager 36, Plug and Play Manager 37, Device Drivers 38, Microkernel 39, Windows Manager and GDI 40, Graphics Device Drivers 41, Object Manager 42, and Hardware Abstraction Layer 43.
User Mode 44 in FIG. 4 contains the following elements Win32 Subsystem Win32 API 45, Windows Application 47, Windows Application 48, Browser Application 49, SL Rendering Engine 50, and SL Controller Plugin 51.

Here the Smudge Lab rendering engine (SL Rendering Engine 50) is an extension to a Browser Application 49, the SL Rendering Engine 50 communicates with the Smudge Lab Controller (SL Controller Plugin 51). The SL Controller Plugin 51 sends commands or instructions with Ring 0 access privileges through the Win32 Subsystem Win32 API 45 into Kernel Mode 40 when implementing Smudge Lab functions with Ring 0 access privileges. The Smudge Lab data repository is not depicted in FIG. 4.

Other functions that may be implemented in Smudge Lab include yet are not limited to the drawing of new Smudge Lab objects, the rotation of Smudge Lab objects over an existing work, and the moving of Smudge Lab objects over an existing work.

Another function of Smudge Lab relates to the sharing of objects and overlays with other client devices. Smudge Lab objects and overlays may be shared with friends, groups, or to anyone depending using permission settings in Smudge Lab overlay meta-data. A user may choose to share their Smudge Lab enhancements, and see other individuals Smudge Lab enhancements to an existing work where a particular existing work is identified by a Smudge Lab UID. Smudge Lab enhancements stored in a data repository are accessed by others with appropriate permission settings. If a particular user has an appropriate permission setting, they may see Smudge Lab enhancements to an existing work. Another user may also be able to provide additional enhancements to a particular existing work that in turn that may be viewed by others with appropriate permission settings. In this way a plurality of Smudge Lab enhancements produced by a plurality of individuals may be shared with a plurality of client devices with appropriate permission settings. Permission settings thus limit or allow the sharing of enhancements superimposed over an existing work that has been created by one or by a plurality of individuals without changing the source code of the existing work.

The invention is not limited to software embodiments like those reviewed above. Other embodiments of the invention include yet are not limited to:
a. Embodiments using hardware only: including field programmable gate arrays (FPGA), application specific integrated circuit (ASIC), or one or more hardware state machines.
b. Embodiments using hardware and firmware/software: including the use of a microprocessor or microcontroller, and at least one program capable of running on the microprocessor or microcontroller implementing one or more discrete state machine functions.

An example of a hardware/firmware implementation is a cell phone capable of displaying internet pages where the hardware operates at the highest level of privileges in the system. In such an embodiment the hardware operates at a level equivalent to software operating on Ring 0 or with Ring 0 access privileges. The firmware in such an embodiment is a simple form of software commonly used in small computing devices and disk drives. Firmware may be written in assembly language or be compiled into from C or other programming language into machine code that is compatible with a micro-controller in a client device.

Smudge Lab functionality implemented within hardware or within hardware/firmware embodiments can also operate at various levels within the architecture of a client device. Similar to the Kernel Mode and User Mode software implementations described above Smudge Lab functionality can be implemented within a core level equivalent to software Kernel Mode, or within a user level equivalent to software User Mode within a client device's architecture.

Smudge Lab functionality implemented within hardware and firmware/software operating may thus operate within the equivalent of Kernel Mode on Ring 0 in software or at the equivalent of User Mode with Ring 0 privileges in software.

The invention may thus be implemented on various types of electronic devices, by various means, even when the electronic devices have different architectural requirements.

Examples of Smudge Lab being used to overlay enhancements (superimposed) over a webpage are shown in FIGS. 5-11. FIGS. 5-11 are an actual reduction to practice of the invention. Item 60 in FIGS. 5-11 is the webpage http://www.chevrolet.com/silverado-pickups/ shows the 2011 SILVERADO HD MOTOR TREND'S 2011 TRUCK OF THE YEAR on the right side of each figure. Item 61 is on the left side of FIGS. 5-11 is a Smudge Lab control window.

Item 62 in FIG. 5 is a set of Smudge Lab enhancements that may be dragged and dropped over a webpage. Control buttons 64, and function tabs 63 are identified in FIG. 5: Control buttons 64 include Control, Undo, and Save; function tabs 63 include Settings, Social, Permissions, Help, Account, Object Editing, My Objects, and Find Objects. Enhancements shown are martini glass, ears, a moustache, a funny face, and a “pow” symbol.

A funny face enhancement 65 is being dragged over the webpage 60 from Smudge Lab 61 in FIG. 6.

Funny face item 65 has been dropped onto webpage 60 in FIG. 7.

FIG. 8 shows webpage 60, Smudge Lab window 61, and funny face 65A that is larger than the funny face in FIG. 7: FIG. 8 is an example of re-sizing an enhancement.

FIG. 9 show webpage 60, Smudge Lab window 61 with Object Editing controls 66 that include Color, Transparency, and Rotation. Item 65B is a funny face the funny face from 65B from FIG. 8 that has been rotated and colored black. FIG. 9 shows that an enhancement may be rotated and colored.

FIG. 10 shows Smudge Lab window 61 with Permissions Functions 67 displayed (Friends <Add New Friend> and Groups <Add New Group>) that may be used when sharing enhancements on top of webpage 60.

FIG. 11 shows Smudge Lab window 61 with Social Networking Functions 68 (Twitter and Facebook) that may be set to share enhancements on top of webpage 60.

### BRIEF DESCRIPTION OF THE DRAWINGS

FIG. 1 entitled “Smudge Lab Initialization Flow” depicts one embodiment of initializing Smudge Lab.

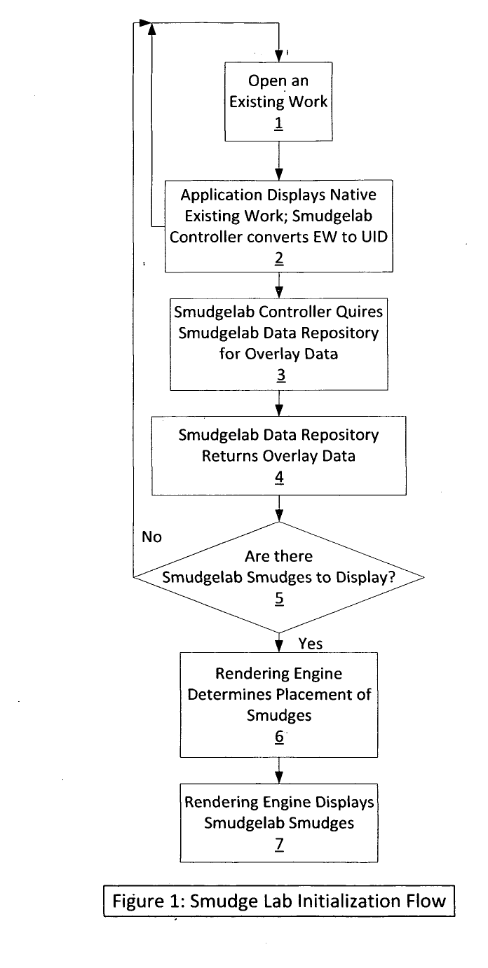

FIG. 2 entitled “Smudge Lab Drag & Drop” illustrates an example of adding a Smudge Lab object above an existing work by dragging a Smudge Lab object from a side bar and dropping it over an existing work.

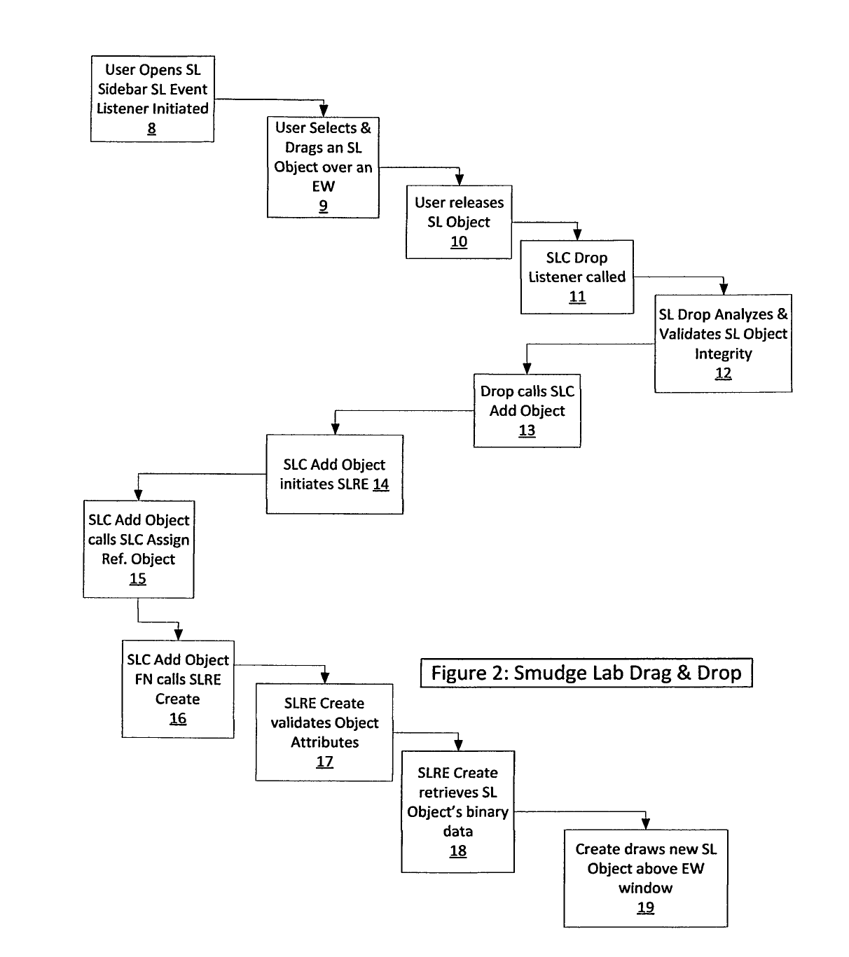

FIG. 3 entitled “Saving Smudge Lab Enhancements” depicts one embodiment of saving enhancements over an existing work to a data repository.

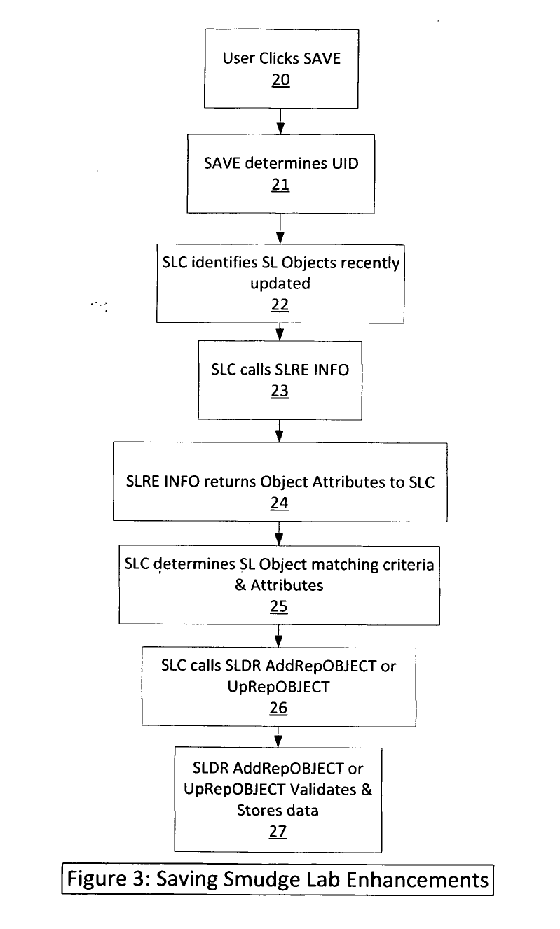

FIG. 4 entitled “Microsoft Windows Architecture with Smudge Lab Functionality” depicts the Smudge Lab Rendering Engine (SL Rendering Engine 50), and Smudge Lab Controller Plugin (SL Controller Plugin 51) being contained within a Browser Application 49 that is located within the classical Microsoft Windows architecture.

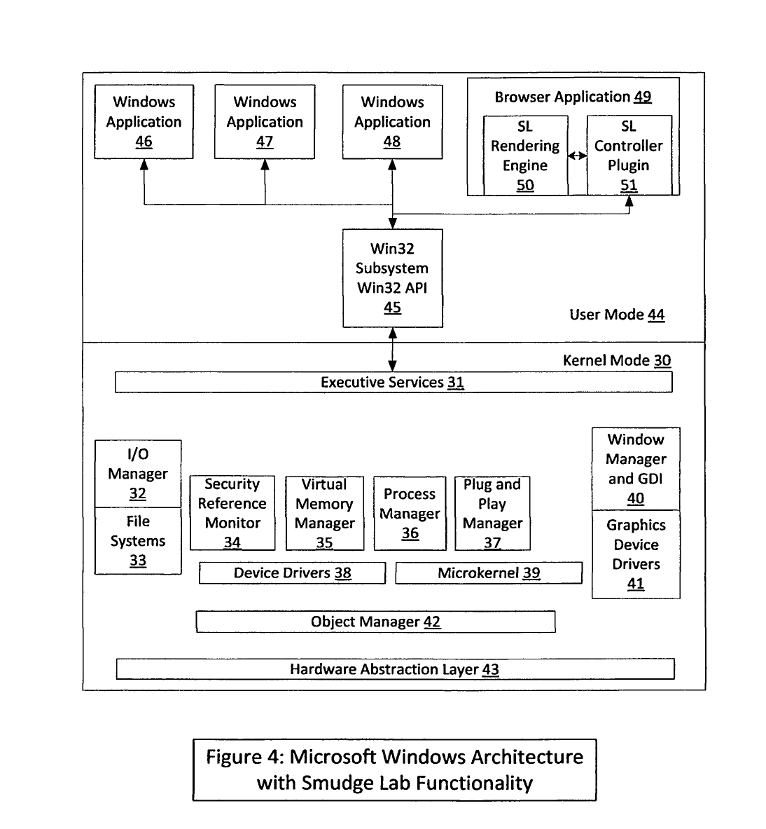

FIG. 5 is an actual example of a web page 60 and a Smudge Lab window 61. Here the Smudge Lab window includes enhancements 62, control tabs 64, and feature tabs 63.

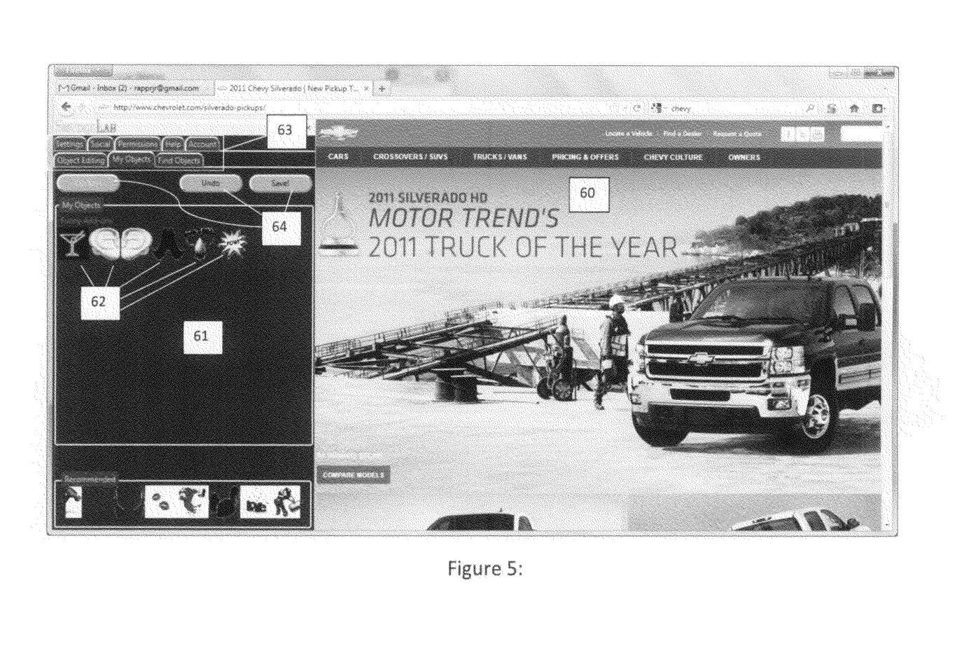

FIG. 6 is an actual example of an enhancement 65 being dragged over a webpage 60 from Smudge Lab window 61.

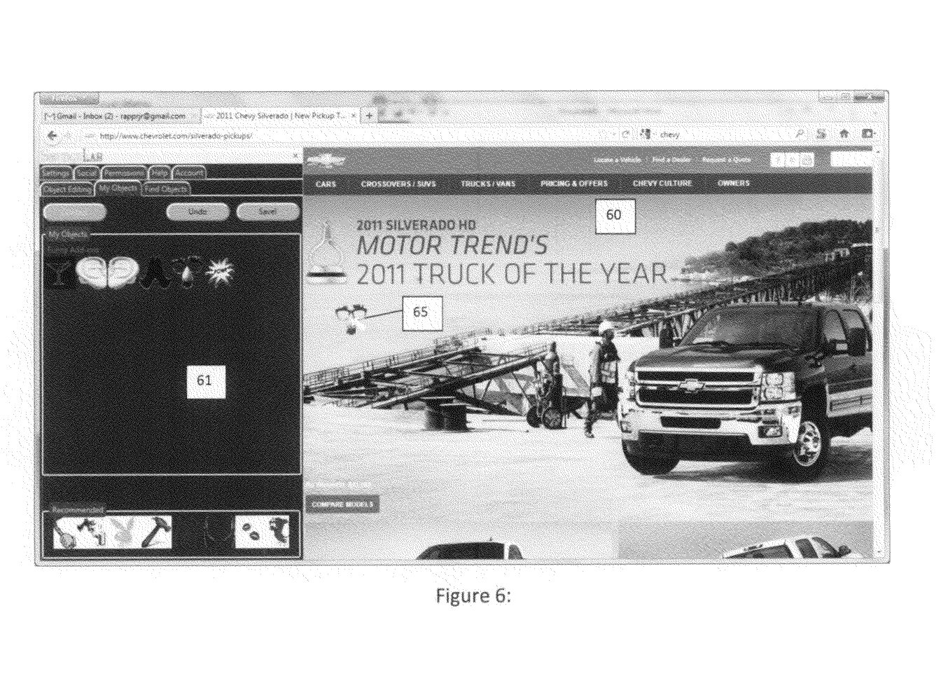

FIG. 7 is an actual example of an enhancement 65 dropped onto webpage 60.

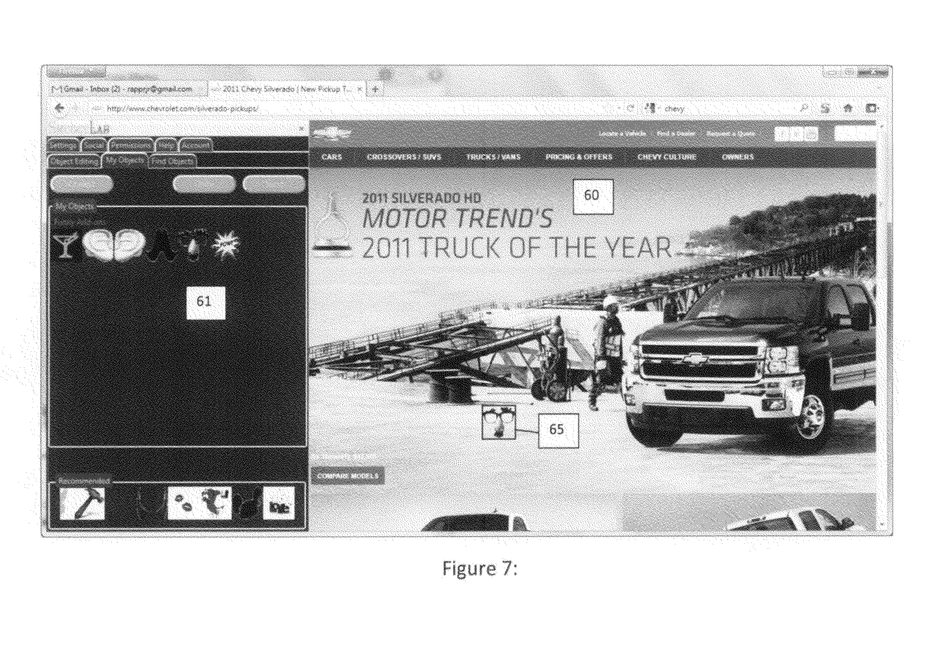

FIG. 8 is an actual example of an enhancement that has been enlarged 65A on webpage 60.

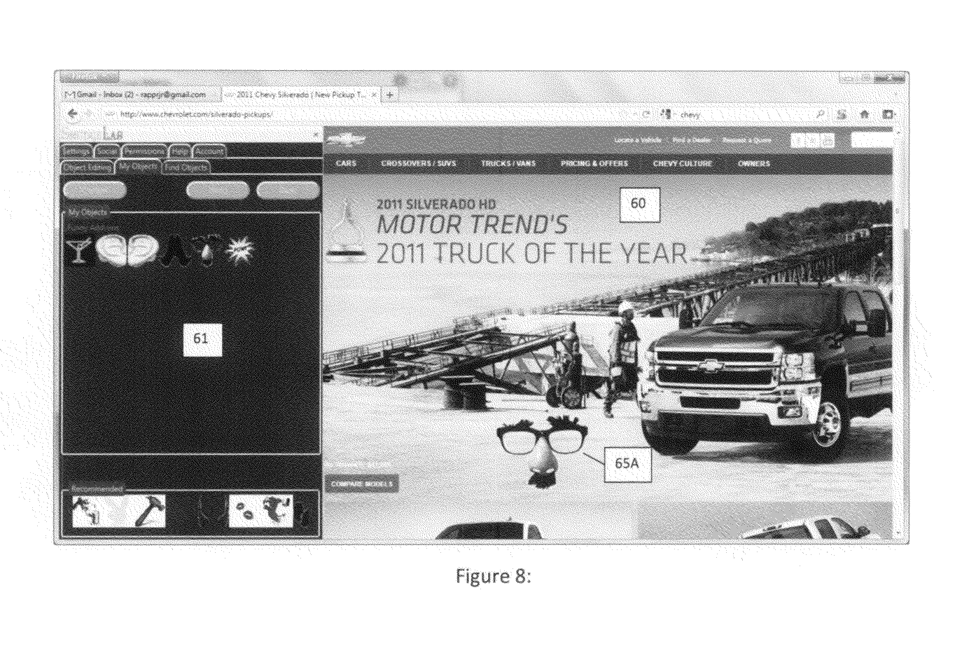

FIG. 9 is an actual example of Object Editing Functions 66 (Color, Transparency, and Rotation) that have been used to rotate and re-color an enhancement 65B.

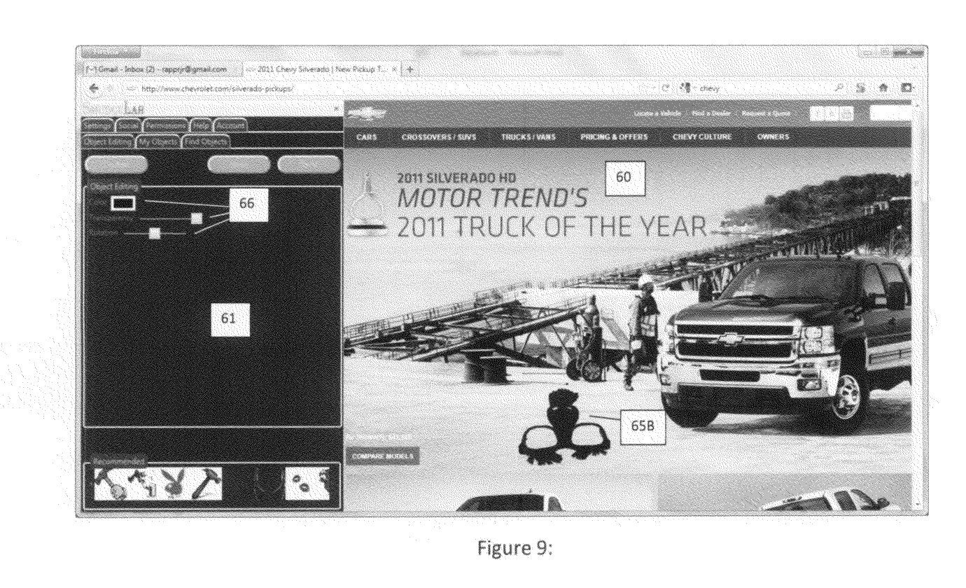

FIG. 10 is an actual example of the Smudge Lab window 61 displaying Permission Functions 67 (Friends <Add New Friend> and Groups <Add New Group>) and webpage 60.

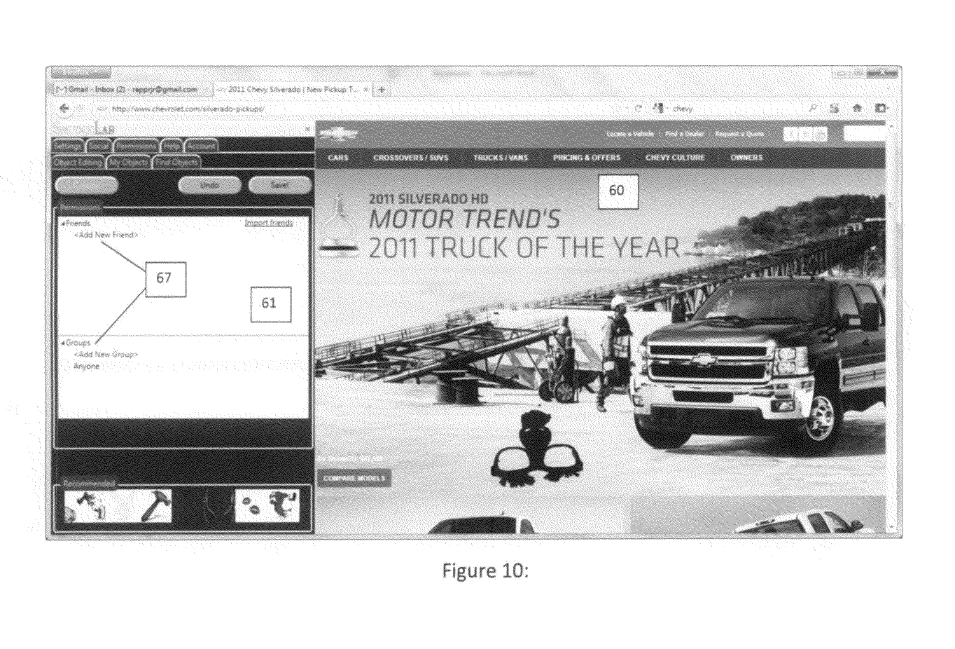

FIG. 11 is an actual example of the Smudge Lab window 61 displaying Social Networking Functions (Twitter, and Facebook) and webpage 60.

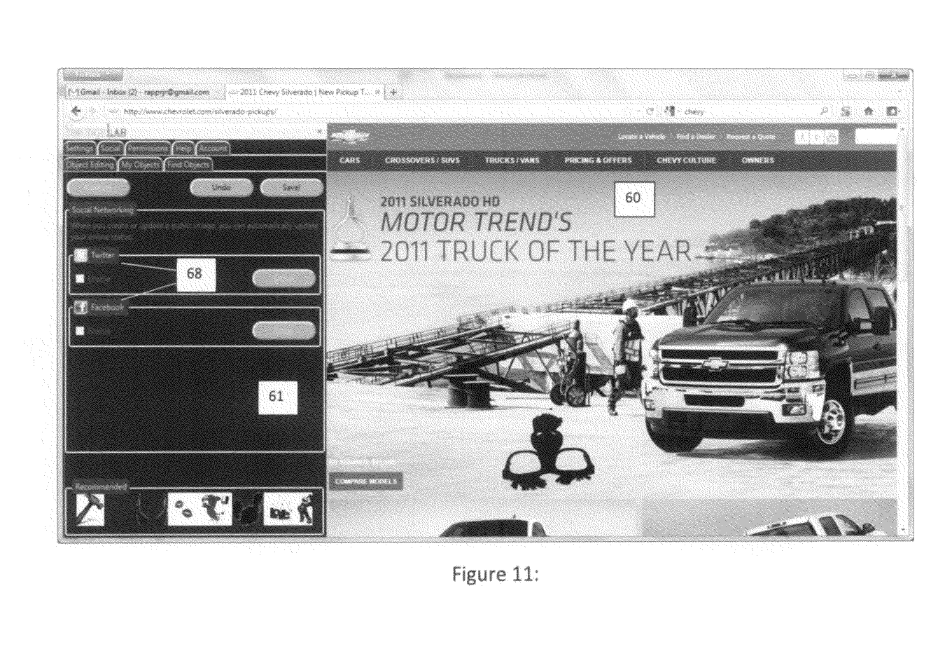

Although the disclosure herein refers to certain illustrated embodiments, it is to be understood that these embodiments have been presented by way of example rather than limitation. Corresponding or related structure and methods specifically contemplated, disclosed and claimed herein as part of this invention, to the extent not mutually inconsistent as will be apparent from the context, this specification, and the knowledge of one skilled in the art, including, modifications thereto, which may be, in whole or in part, (i) operable and/or constructed with, (ii) modified by one skilled in the art to be operable and/or constructed with, and/or (iii) implemented/made/used with or in combination with, any parts of the present invention according to this disclosure, include: (I) any one or more parts of the above disclosed or referenced structure and methods and/or (II) subject matter of any one or more of the following claims and parts thereof, in any permutation and/or combination include the subject matter of any one or more of the following claims, in any permutation. The intent accompanying this disclosure is to have such embodiments construed in conjunction with the knowledge of one skilled in the art to cover all modifications, variations, combinations, permutations, omissions, substitutions, alternatives, and equivalents of the embodiments, to the extent not mutually exclusive, as may fall within the spirit and scope of the invention as limited only by the appended claims.

1: A method operating on one or more state machines on one or more client devices initialized during or after opening at least one existing work on a client device comprising:
said one or more state machines identifying and generating a universal identifier identifying said at least one existing work;
said one or more state machines identifying objects or items contained within said at least one existing work; and
said one or more state machines displaying content superimposed over said at least one existing work without modifying said at least one existing work's source code.

2: The method of claim 1 further comprising storing of said content superimposed over said at least one existing work in a data repository.

3: The method of claim 2 further comprising retrieving of said content superimposed over said at least one existing work from said data repository.

4: The method of claim 3 further comprising:
sharing said data repository with one or more other client devices; and
viewing or listening to said content superimposed over said at least one existing work by accessing a data repository shared with one or more other client devices.

5: The method of claim 4 further comprising access privilege information identifying which users, friends, groups, or others who have access to view, or listen to said content superimposed over said at least one existing work.

6: The method of claim 5 further comprising access privilege information identifying which users, friends, groups, or others who have access to modify said content superimposed over said at least one existing work in said shared data repository created by another individual.

7: The method of claim 4 implemented in software.

8: The method of claim 4 implemented in hardware.

9: The method of claim 4 implemented in hardware and firmware.

10: The method of claim 4 implemented in hardware and software.

11: A product operating on one or more state machines on one or more client devices initialized during or after opening at least one existing work on a client device comprising:
said one or more state machines identifying and generating a universal identifier identifying said at least one existing work;
said one or more state machines identifying objects or items contained within said at least one existing work; and
said one or more state machines displaying content superimposed over said at least one existing work without modifying said at least one existing work's source code.

12: The product of claim 11 further comprising storing of said content superimposed over said at least one existing work in a data repository.

13: The product of claim 12 further comprising retrieving of said content superimposed over said at least one existing work from said data repository.

14: The product of claim 13 further comprising:
sharing said data repository with one or more other client devices; and
viewing or listening to said content superimposed over said at least one existing work by accessing a data repository shared with one or more other client devices.

15: The product of claim 14 further comprising access privilege information identifying which users, friends, groups, or others who have access to view or listen to said content superimposed over said at least one existing work.

16: The product of claim 15 further comprising access privilege information identifying which users, friends, groups, or others who have access to modify said content superimposed over said at least one existing work in said shared data repository created by another individual.

17: The product of claim 14 implemented in software.

18: The product of claim 14 implemented in hardware.

19: The product of claim 14 implemented in hardware and firmware.

20: The product of claim 14 implemented in hardware and software.
